(19) United States
(12) Patent Application Publication
(10) Pub. No.: US 2008/0095998 A1
(43) Pub. Date: Apr. 24, 2008

(54) Multilayer Material for Heat Protective Garments

(75) Inventor: Laurent Thiriot, Roubaix (FR)

Correspondence Address: KENYON & KENYON LLP, 1500 K STREET N.W., SUITE 700, WASHINGTON, DC, 20005, US

(73) Assignee: KERMEL, Colmar (FR)

(21) Appl. No.: 11/793,388

(22) PCT Filed: Dec. 16, 2005
(86) PCT No.: PCT/FR05/03172

§ 371 Date: Jun. 19, 2007

(30) Foreign Application Priority Data
Dec. 20, 2004 (FR) 0413614

(51) Int. Cl. B23B 7/02

(52) U.S. Cl. 428/219

(57) ABSTRACT

The present invention relates to a multilayer material for the production of protective clothing, in particular for firefighters, comprising, from the exterior toward the interior: a double-layer exterior fabric comprised of an exterior side and an interior side; optionally a membrane support; a waterproof/breathable membrane; optionally a thermal barrier; an interior lining. Characteristically, the exterior fabric has a weight equal to or greater than 285 g/m² and the ratio between the weight per square meter of the layers located in front of the membrane and that of the layers located behind the membrane is greater than or equal to 1.8.

The present invention relates generally to the field of multilayer textile materials used to produce clothing that is protective against heat and fire, in particular for firefighters. The invention leads in particular to a multilayer material with an exterior fabric comprised of a double layer whose weight is equal to or greater than 285 g/m².

Clothing that is protective against heat and fire must meet a certain number of criteria, in particular:
protection against radiant heat and convective heat;
good thermal stability of the constitutive materials;
nonflammability;
good impermeability;
breathability;
broad freedom of movement.

To date, to produce firefighter suits, multilayer structures generally weighing between 500 g/m² and 700 g/m² are used which, generally speaking, are composed of four or five layers. For example, one such structure is composed of the superposition of the following layers:
an exterior fabric (first layer) typically weighing between 200 g/m² and 250 g/m²;
a waterproof/breathable membrane (second layer) of 50 g/m², generally combined with a substrate (third layer) of 100 g/m² placed between the membrane and the exterior fabric;
a thermal barrier (fourth layer), generally comprised of needled felt of 100 g/m² to 200 g/m²;
an inside liner (fifth layer) of approximately 130 g/m².

For these types of materials, the weight of the layers located in front of the membrane is between 300 g/m² and 350 g/m², and that of the layers located behind the membrane is between 230 g/m² and 330 g/m². A layer is considered to be located in front of the membrane when it is on the exterior side of the clothing when worn by the user with respect to the aforesaid membrane. Conversely, a layer is considered to be located behind the membrane when it is on the interior side of the clothing when worn by the user with respect to the membrane. Thus, the weight ratio between the layers in front of the membrane and the layers behind the membrane is in the range of 0.9 to 1.6.

However, the applicant has demonstrated, and this is one of the merits of the invention, that, in a surprising manner, for a multilayer material having a given weight per square meter, the fact of putting a greater weight load in front of the membrane, in particular by the use of a heavier exterior fabric, and of thus increasing the ratio between the weight of the layers located in front of the membrane and that of the layers located behind the membrane, improves the resistance of said multilayer materials to high temperatures and, as a result, improves the protection of firefighters when responding to a fire.

The purpose of the present invention is to propose a multilayer material with improved thermal properties for use in the production of protective clothing, in particular for firefighters.

The present invention has led to a multilayer material intended for the production of protective clothing, in particular for firefighters, comprising, from the exterior toward the interior:
a double-layer exterior fabric comprised of an exterior side and an interior side;
optionally a membrane support;
a waterproof/breathable membrane;
optionally a thermal barrier;
an interior lining,
   the aforesaid material being characterized wherein the exterior fabric has a weight equal to or greater than 285 g/m² and wherein the ratio between the weight per square meter of the layers located in front of the membrane and that of the layers located behind the membrane is greater than 1.8, preferably between 3 and 4.

In addition, other technical solutions suggest increasing the thermal insulation capacity of protective clothing by using structures likely to trap air. This choice responds in particular to the constant concern with regard to improving insulating properties without reducing breathability or freedom of movement, above all without increasing the total weight of the clothing.

To this end, the invention relates to a multilayer material as described above, wherein:
the aforesaid exterior side is made of thermoreactive threads or fibers;
the aforesaid interior side is made of heat-stable threads or fibers, optionally in alternation with thermoreactive threads or fibers.

In a preferred manner, the exterior and interior sides are connected by intermittent bonding.

Advantageously, retraction of the aforesaid exterior side under the effect of heat takes place in the machine direction.

In an alternative embodiment, the aforesaid thermoreactive threads or fibers integrated in the aforesaid interior side are in the cross-machine direction.

In another alternative embodiment, the aforesaid thermoreactive threads or fibers integrated in the aforesaid second interior layer are in the machine direction.

“Thermoreactive threads or fibers” means threads or fibers exhibiting a certain capacity to retract under the effect of heat while maintaining a certain integrity of the material.

Preferably, the thermoreactive threads or fibers belong to the family of meta-aramids, whereas the best choice for heat-stable fibers is the para-aramids or PBO.

The invention will be better understood upon consideration of the following detailed description and appended figures in which:

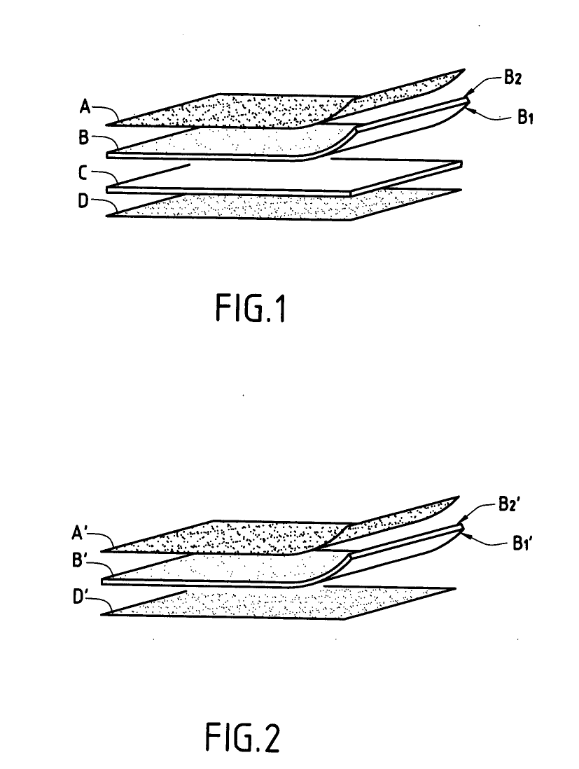

FIG. 1 is a schematic representation of a conventional multilayer complex;

FIG. 2 is a schematic representation of a multilayer complex according to the invention;

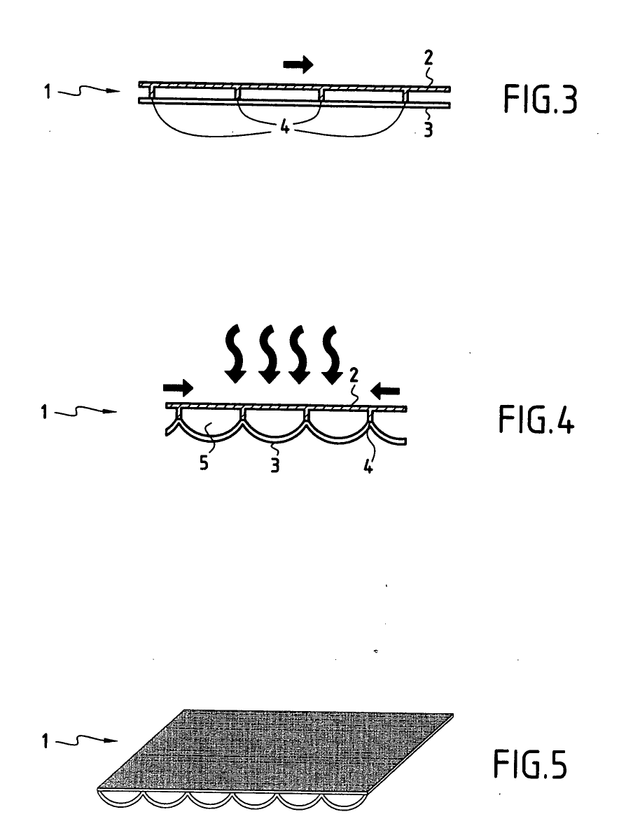

FIG. 3 is a conventional view of an exterior fabric in conformity with the invention, seen in cross-section;

FIG. 4 represents the exterior fabric of FIG. 3, under the effect of heat;

FIG. 5 represents the exterior fabric of FIG. 4, seen in perspective;

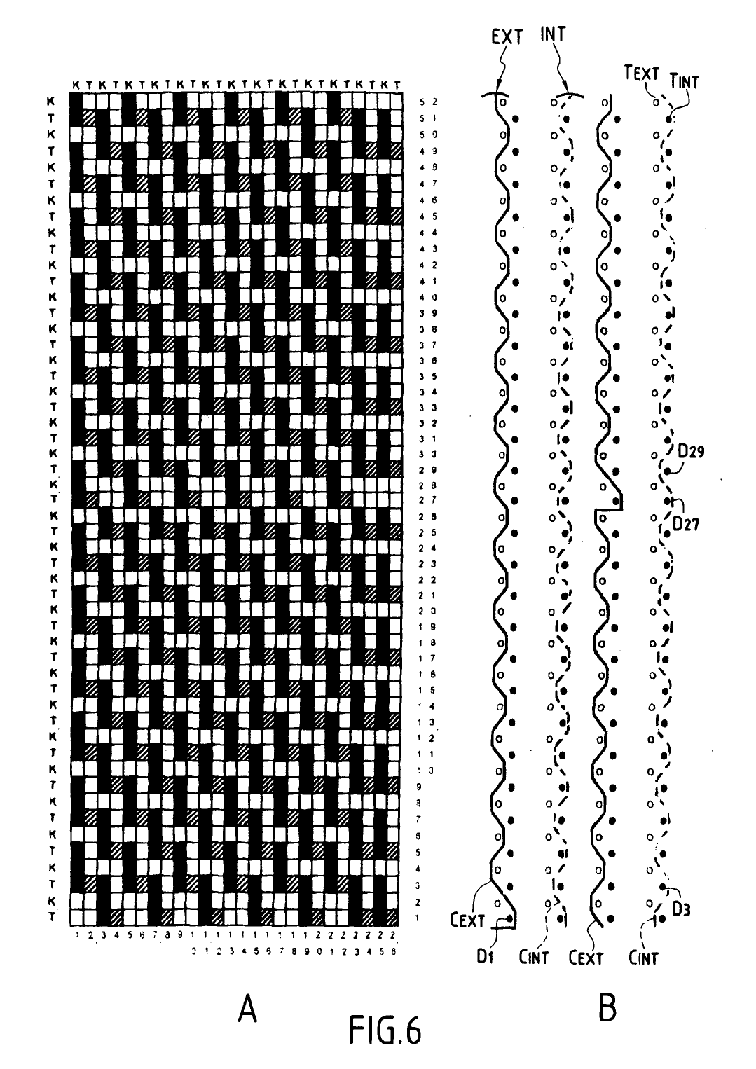

FIG. 6 represents the typical weave of the exterior fabric according to one embodiment, with a conventional view (FIG. 6a) and a longitudinal view (FIG. 6b).

FIG. 1 illustrates a multilayer complex, with five layers, typically used for the production of clothing that is protective against heat and fire, in particular for firefighters. In this figure, layer A indicates the exterior fabric, layer B indicates the unit formed by membrane B₁ with its support B₂, layer C indicates the needled felt matelassé and layer D indicates the lining.

FIG. 2 illustrates a multilayer complex, with four layers, according to the invention. In this figure, layer A′ indicates the double-layer exterior fabric, layer B′ indicates the unit formed by membrane B′₁ and its support B′₂, and layer D′ indicates the lining. In this complex there is no thermal barrier.

FIG. 3 is a schematic cross-sectional view of an exterior double-layer fabric, in conformity with the invention, under normal temperature conditions. Exterior fabric 1 has an exterior side 2 and an interior side 3 interconnected by connection points 4.

FIGS. 4 and 5 schematically illustrate, in a cross-sectional view and in a perspective view, the thermal mode of reaction of the exterior fabric of FIG. 3 when the aforesaid is subjected to a sudden increase in temperature.

FIG. 6 illustrates the typical weave of the exterior fabric in one embodiment, with a concrete example of its structure. FIG. 6a is a conventional view of the weave design. FIG. 6b is a longitudinal view illustrating the way in which the two layers 2 and 3 are interdependent.

One object of the invention is a multilayer material comprising an exterior fabric whose weight is equal to or greater than 285 g/m² and for which the ratio between the weight per square meter of the layers located in front of the membrane and that of the layers located behind the membrane is greater than 1.8.

A study has demonstrated a significant improvement in the effectiveness of the novel complex.

A comparison was made between an example of the complex according to the invention and two conventional types of complexes, all containing the same membrane (of microporous polyurethane) laminated to the same support (100% nonwoven aramid fabric, 100 g/m²). The exterior fabric of “conventional” construction of the two control complexes is a meta-aramid/para-aramid mixture. One of the controls (complex cx1) is a conventional complex that offers very good protection. The other (complex cx2) is a very thin complex that optimizes comfort while meeting the lower limits of thermal protection standards for firefighter clothing (according to the EN 469 standard). The thermal protection test standards used were standard EN 367 for convective heat protection and ISO 6942 for radiant heat protection.

Complex cx1 is comprised of the following layers:
an exterior fabric of 200 g/m²;
a membrane support B₂ of 100 g/m²;
a membrane B₁ of 50 g/m²;
a felt layer C and a lining D of 220 g/m².

Complex cx2 is comprised of the following layers:
an exterior fabric of 200 g/m²;
a membrane support B₂ of 100 g/m²;
a membrane B₁ of 50 g/m²;
a lining D of 165 g/m².

In spite of their quite different performances with respect to protection and comfort, the two complexes cx1 and cx2 had equivalent ratios of thermal protection to evaporative resistance (R_{e,T}) of approximately 0.8 for the convective heat protection ratio HTI24/R_{e,T}, and approximately 1 for the radiant heat protection ratio RTI24/R_{e,T}.

The complex according to the invention tested in this comparative study is composed of the following layers:
a double layer of exterior fabric (A′) of 320 g/m²;
a membrane support (B′2) of 100 g/m²;
a membrane (B′) of 50 g/m²;
an aramid/viscose lining (D′) of 130 g/m².

In this complex, the ratio of the weight of the layers located in front of the membrane to the weight of the layers located behind the membrane is 3.23.

This multilayer complex is characterized by an HTI/R_{e,T} ratio of approximately 1 (an increase of 20% compared to conventional complexes), whereas the RTI24/R_{e,T} ratio is approximately 1.35 (an increase of 35% compared to conventional complexes), as measured by means of the ISO 6942 standard for radiant heat and the FR EN 367 standard for convective heat.

The improved performance obtained in the case of the multilayer complex according to the invention can be explained by the fact that to put a higher weight load in front of the membrane increases the thermal exposure time necessary to destroy the membrane, thus extending the period before hot air is able to cross the complex directly.

An exterior fabric with a weight greater than or equal to 285 g/m² provides a better comfort/protection ratio for protective clothing.

The double-layer exterior fabric in the multilayer material composition according to the invention is produced by weaving or knitting in such a way as to form a double-sided structure, with the exterior and interior sides interconnected intermittently. For example, the threads in the machine direction of the exterior side are intermittently interlaced with the cross-machine threads of the interior side. The term “fabric” is used generically, independent of the bonding method, whether by weaving or by knitting. Preferably, in the two-sided structure of the exterior fabric, each of the two sides has threads that possess a certain capacity to retract under the effect of heat, this effect being differentiated from one side to the other.

Advantageously, the retraction of the aforesaid first exterior side under the effect of heat takes place in the machine direction.

In one embodiment, the aforesaid thermoreactive threads or fibers integrated in the aforesaid interior side are in the cross-machine direction. In another embodiment, the aforesaid thermoreactive threads or fibers integrated in the aforesaid interior side are in the machine direction.

The thermoreactive threads or fibers are distributed in the interior side according to at least one direction and are separated at least partly by threads that are dimensionally stable under the effect of heat.

The thermoreactive threads or fibers used in the composition of the exterior side and the interior side preferably belong to the family of meta-aramids. The threads or fibers used in the composition of the interior side that are dimensionally stable under the effect of heat preferably belong to the family of para-aramids.

According to an alternative embodiment, the multilayer material according to the invention improves thermal insulation during exposure to a significant thermal flow by virtue of the capacity of the exterior fabric to increase its thickness via dual retraction under the effect of heat. Initially, when the temperature of exterior side 2 is sufficiently high (FIGS. 4 and 5), the thermoreactive threads used in the composition of the aforesaid side 2 retract, thus leading to the formation of pockets 5 between the two sides 2 and 3 as a result of the intermittent bonds 4, as well as to the fact that interior side 3 does not undergo the same retraction. These pockets 5 create a thermal barrier in front of the interior side 3 of the exterior fabric 1, the aforesaid thermal barrier consisting of the air trapped inside the aforesaid pockets.

This insulating effect produces an additional delay in the passage of hot air penetrating exterior side 2 before it reaches interior side 3.

It is only when the temperature of interior side 3 reaches the retraction temperature of the thermoreactive threads used in the composition of the aforesaid side 3 that retraction of the latter occurs, thus leading to the formation of bosses in interior side 3. This is possible because the thermoreactive threads or fibers are distributed in interior side 3 according to at least one direction and are separated at least partly by threads that are dimensionally stable under the effect of heat.

The air trapped in the pockets and bosses formed between exterior side 2 and interior side 3, and in the possible bosses formed between interior side 3 and the membrane support, constitutes a protective barrier which extends the time necessary for hot air to cross exterior fabric 1 and to reach the membrane.

The exterior side consists of thermoreactive threads or fibers in the machine direction and in the cross-machine direction. Such threads are preferably fiber yarns comprised of a mixture of meta-aramid fibers and anti-static fibers. In the case of Kermel® meta-aramid fibers, the retraction temperature is approximately 300° C. (material temperature). The time required for the material to reach this temperature depends on several factors, in particular the heat source and the fabric density.

The interior side is comprised of heat-stable threads or fibers, optionally in alternation with thermoreactive threads or fibers if a dual retraction effect is sought. In the latter case, the thermoreactive threads or fibers are distributed in the interior side according to at least one direction and are separated at least partly by threads that are dimensionally stable under the effect of heat, in such a way that the aforesaid interior side forms cells in relief or bosses under the effect of heat and of preferential retraction of the thermoreactive threads.

The distribution of the thermoreactive threads in the interior side can be regular or irregular, according to a given surface direction. According to a specific embodiment of the interior side, the distribution of the thermoreactive threads, according to at least one direction of the side, is regular.

The interior side is advantageously a woven or knitted surface, preferably a woven surface. The thermoreactive threads present in the interior side are in the machine direction or in the cross-machine direction. They are distributed in the machine direction and/or the surface cross direction. They may be present in the machine direction alone or in the cross-machine direction alone.

The thermoreactive threads are separated at least partly from each other by a certain number of heat-stable threads in the interior side.

The thermoreactive threads used in the composition of the interior side are threads selected from the group comprised of the aromatic meta-aramids, melamine, polyimides, polyacrylates and polyphenylenes.

The threads that are dimensionally stable under the effect of heat used in the composition of the interior side are selected from the group comprised of the para-aramids, PBO (polyparaphenylene-2,6-benzobisoxazole) and similar compounds.

The thermoreactive threads or fibers may be used alone or mixed with threads or fibers that are dimensionally stable under the effect of heat. One example is a mixture of modacrylic and para-aramid.

The double-layer exterior fabric used in the composition of a multilayer complex according to the invention is produced by weaving or knitting in such a way as to form a structure with two sides intermittently interconnected. The aforesaid exterior and interior sides are interconnected in such a way that the machine direction threads of the exterior side pick up the cross-machine threads of the interior side. This type of structure creates pockets in the exterior side when the aforesaid is subjected to a temperature that is sufficiently high to cause retraction of the thermoreactive threads used in its composition.

In addition, the presence of para-aramid threads in the interior side of the double-layer fabric in conformity with the invention gives the aforesaid fabric high mechanical and fire resistance, without the known disadvantages of this type of thread, in particular sensitivity to ultraviolet rays and to abrasion, by virtue of the interior position of this side in the double-layer fabric exterior side.

A first precise example of an embodiment, given as a non-limiting example, the double-layer exterior fabric (A′), in conformity with the weave design of FIG. 6a and with the mode of bonding between the two sides of FIG. 6b, totals 295 g/m². The exterior side is solely comprised of thermoreactive threads, specifically 99/1 meta-aramid/anti-static fiber thread with a metric count of 70/2. The interior side is solely comprised of dimensionally-stable thread, specifically 100% para-aramid thread with a metric count of 100/2. The bonding between the two sides is achieved by the intermittent picking up by some machine direction threads of the exterior side of some cross-machine direction threads of the interior side.

The example illustrated in FIG. 6 discloses a double-layer fabric composed of machine direction threads (C_{EXT}) and cross-machine direction threads (T_{EXT}) of 70/2 metric count meta-aramid for the exterior side (EXT) and machine direction threads (C_{INT}) and cross-machine direction threads (T_{INT}) of 100/2 metric count para-aramid for the interior side (INT). The machine direction threads (C_{EXT}) of the exterior side (EXT) intertwine alternately with picks no. 1 (D₁) and no. 27 (D₂₇) belonging to the interior side (TNT). As a result, this design interconnects the two sides and, at the same time, creates flat channels (pockets) in the cross-machine direction of the fabric.

A second example of an embodiment consists of replacing weave picks nos. 1 (D₁), 3 (D₃), 27 (D₂₇) and 29 (D₂₉) of the interior side (TNT) with thermoreactive threads. Independently of the double-layer structure, the interior side is then equivalent to a fabric made of para-aramid threads, containing stripes of thermoreactive threads in the cross-machine direction approximately every 5 mm. Functionally, when these threads are heated to a sufficiently high temperature during use (approximately 300° C. in the case of thermoreactive meta-aramid thread), they will pull the stable para-aramid thread structure, causing the fabric to wrinkle systematically, thereby increasing the thickness of the interior side and thus its insulating capacity.

As an example of a particularly effective multilayer complex for the production of firefighter clothing, this exterior double-layer fabric could be combined with the following layers:
polytetrafluoroethylene (PTFE) or microporous or absorbent polyurethane membrane, laminated to a nonwoven support material of 100% aramid, 85 g/m²;
50/50 aramid/viscose FR lining, 115 g/m²,
   for a total weight of the complex of approximately 550 g/m². To further increase thermal protection, a 55 g/m² layer of 100% nonwoven aramid matelassé material can be added to the lining for a total weight of the complex of approximately 600 g/m².

1. A multilayer material for the production of protective clothing, in particular for firefighters, comprising, from the exterior toward the interior:
a double-layer exterior fabric comprised of an exterior side and an interior side;
optionally a membrane support;
a waterproof/breathable membrane;
optionally a thermal barrier;
an interior lining,
wherein the exterior fabric has a weight equal to or greater than 285 g/m² and wherein the ratio between the weight per square meter of the layers located in front of the membrane and that of the layers located behind the membrane is greater than or equal to 1.8.

2. A material according to claim 1, wherein:
the exterior side is made of thermoreactive threads or fibers;
the interior side is made of threads or fibers that are dimensionally stable under the effect of heat, optionally in alternation with thermoreactive threads or fibers.

3. A material according to claim 1, wherein the exterior and interior sides are connected by intermittent bonding.

4. A material according to claim 1, wherein retraction of the exterior side under the effect of heat takes place in the machine direction.

5. A material according to claim 2, wherein the aforesaid thermoreactive threads or fibers integrated in the interior side are in the cross-machine direction.

6. A material according to claim 2, wherein the aforesaid thermoreactive threads or fibers integrated in the interior side are in the machine direction.

7. A material according to claim 2, wherein the aforesaid thermoreactive threads or fibers are selected from the group comprising meta-aramids, melamine, aromatic polyimides, polyacrylates and polyphenylenes.

8. A material according to claim 2, wherein the aforesaid threads or fibers that are dimensionally stable under the effect of heat are selected from the group comprising para-aramids, PBO (polyparaphenylene-2,6-benzobisoxazole) and similar compounds.

9. A material according to claim 1, wherein, in exterior fabric, the machine direction threads of the exterior side take the cross-machine direction picks of the interior side.

10. Clothing that is protective against heat and fire, in particular firefighter clothing, produced by using the multilayer material according to claim 1.

11. Use of the multilayer material according to claim 1 for the production of clothing that is protective against heat and fire.

12. A material according to claim 3, wherein retraction of the exterior side under the effect of heat takes place in the machine direction.

13. A material according to claim 3, wherein the aforesaid thermoreactive threads or fibers integrated in the interior side are in the cross-machine direction.

14. A material according to claim 3, wherein the aforesaid thermoreactive threads or fibers integrated in the interior side are in the machine direction.
